(19) United States
(12) Patent Application Publication
(10) Pub. No.: US 2024/0224221 A1
(43) Pub. Date: Jul. 4, 2024

(54) METHOD AND APPARATUS FOR INDOOR POSITIONING IN COMMUNICATION SYSTEM

(71) Applicant: ELECTRONICS AND TELECOMMUNICATIONS RESEARCH INSTITUTE, Daejeon (KR)

(72) Inventors: Seok Bong HYUN, Daejeon (KR); Sung Jun LEE, Daejeon (KR); Sun Woo KONG, Daejeon (KR); Bong Hyuk PARK, Daejeon (KR); Hui Dong LEE, Daejeon (KR); Seung Hyun JANG, Daejeon (KR)

(73) Assignee: ELECTRONICS AND TELECOMMUNICATIONS RESEARCH INSTITUTE, Daejeon (KR)

(21) Appl. No.: 18/491,468

(22) Filed: Oct. 20, 2023

(30) Foreign Application Priority Data
Dec. 29, 2022 (KR) 10-2022-0189882

(51) Int. Cl. H04W 64/00; G01S 5/02

(52) U.S. Cl. CPC H04W 64/00; G01S 5/0218

(57) ABSTRACT

An operation method of a first communication node may comprise: receiving a first signal from a second communication node of the communication system; estimating a first time interval corresponding to a first path detected as a FAP among one or more paths through which the first signal is received; defining a first gain control function based on the estimated first time interval; receiving a second signal transmitted from the second communication node by variably controlling a reception gain based on the first gain control function; estimating a second time interval corresponding to a DP between the first and second communication nodes, based on a result of receiving the second signal based on the first gain control function; and transmitting relative distance information on the second time interval to a first positioning device.

### CROSS-REFERENCE TO RELATED APPLICATIONS

This application claims priority to Korean Patent Application No. 10-2022-0189882, filed on Dec. 29, 2022, with the Korean Intellectual Property Office (KIPO), the entire contents of which are hereby incorporated by reference.

### BACKGROUND

### 1. Technical Field

Exemplary embodiments of the present disclosure relate to an indoor positioning technique in a communication system, and more specifically, to a positioning technique for position measurement performance enhancement based on cellular networks using multiple antennas.

### 2. Related Art

With the development of information and communication technology, various wireless communication technologies are being developed. Representative wireless communication technologies include long term evolution (LTE) and new radio (NR) defined as the 3rd generation partnership project (3GPP) standards. The LTE may be one of 4th generation (4G) wireless communication technologies, and the NR may be one of 5th generation (5G) wireless communication technologies. A wireless communication technology after the 5G wireless communication technology (e.g., the sixth generation (6G) wireless communication technology, etc.) may be referred to as ‘beyond-5G (B5G) wireless communication technology’.

In an exemplary embodiment of a communication system, a receiving node may perform positioning (i.e., position measurement) of itself or a transmitting node based on received radio signals. Here, the positioning may be performed based on various techniques such as triangulation schemes relying on multiple radio signals. Such positioning operations can be easily performed when the transmitting and receiving nodes are under a line-of-sight (LOS) condition. Global Positioning System (GPS) is a well-known method of outdoor positioning under LOS condition. However, in cases where the transmitting and receiving nodes are under a non-line-of-sight (NLOS) condition, the accuracy of positioning operations may deteriorate. For example, in an exemplary embodiment of a communication system using multiple antennas, when a direct path (DP) between the transmitting and receiving nodes is blocked, reception signals at the receiving node are primarily reflected off other objects after being transmitted from the transmitting node before reaching the receiving node. In such cases, a distance between transmitting and receiving nodes may be perceived as greater than it actually is, making accurate positioning challenging. Therefore, techniques for enhancing the accuracy of reception signal-based positioning operations in the communication system are required.

Matters described as the prior arts are prepared to help understanding of the background of the present disclosure, and may include matters that are not already known to those of ordinary skill in the technology domain to which exemplary embodiments of the present disclosure belong.

### SUMMARY

Exemplary embodiments of the present disclosure are directed to providing a positioning method and apparatus for a communication node using multiple antennas to perform a positioning operation with high accuracy based on reception signals.

According to a first exemplary embodiment of the present disclosure, an operation method of a first communication node in a communication system may comprise: receiving a first signal from a second communication node of the communication system; estimating a first time interval corresponding to a first path detected as a first arrival path (FAP) among one or more paths through which the first signal is received; defining a first gain control function based on the estimated first time interval; receiving a second signal transmitted from the second communication node by variably controlling a reception gain based on the first gain control function; estimating a second time interval corresponding to a direct path (DP) between the first and second communication nodes, based on a result of receiving the second signal based on the first gain control function; and transmitting information on the second time interval to a first positioning device, wherein the information on the second time interval is used for the first positioning device to perform a positioning operation for the second communication node.

The operation method may further comprise, after receiving the first signal, estimating a first angle of arrival corresponding to the FAP.

The first gain control function may be defined to change the reception gain of the first communication node from a first gain to a second gain, based on the estimated first time interval.

The receiving of the second signal may comprise: controlling a reception gain for a component received before the estimated first time interval to a first gain, based on the first gain control function; and controlling a reception gain for a component received after the estimated first time interval to a second gain that is smaller than the first gain, wherein the second time interval has a smaller value than the first time interval.

In the estimating of the second time interval, when the estimated second time interval and the estimated first time interval have a same value, the first path may be determined to correspond to the direct path.

The operation method may further comprise, after receiving the second signal, estimating a second angle of arrival corresponding to the direct path, wherein in the transmitting of the information on the second time interval to the first positioning device, information on the second angle of arrival may be transmitted to the first positioning device together with the information on the second time interval.

The operation method may further comprise: receiving a positioning request signal from the second communication node before receiving the first signal; and determining whether the second communication node is located indoors or outdoors based on the positioning request signal.

The operation method may further comprise: receiving information on an estimated position of the second communication node from the first positioning device after the transmitting to the first positioning device; and performing communication with the second communication node based on the information on the estimated position.

The operation method may further comprise: receiving information on an estimated position of the second communication node from the first positioning device after the transmitting to the first positioning device; and transmitting information on the estimated position to the second communication node.

According to a second exemplary embodiment of the present disclosure, a first communication node in a communication system may comprise a processor, and the processor may cause the first communication node to perform: receiving a first signal from a second communication node of the communication system; estimating a first time interval corresponding to a first path detected as a first arrival path (FAP) among one or more paths through which the first signal is received; defining a first gain control function based on the estimated first time interval; receiving a second signal transmitted from the second communication node by variably controlling a reception gain based on the first gain control function; estimating a second time interval corresponding to a direct path (DP) between the first and second communication nodes, based on a result of receiving the second signal based on the first gain control function; and performing a positioning operation for the second communication node based on information on the second time interval.

The processor may further cause the first communication node to perform: after receiving the first signal, estimating a first angle of arrival corresponding to the FAP.

In the receiving of the second signal, the processor may further cause the first communication node to perform: controlling a reception gain for a component received before the estimated first time interval to a first gain, based on the first gain control function; and controlling a reception gain for a component received after the estimated first time interval to a second gain that is smaller than the first gain, wherein the second time interval has a smaller value than the first time interval.

In the estimating of the second time interval, the processor may further cause the first communication node to perform: when the estimated second time interval and the estimated first time interval have a same value, determining the first path as corresponding to the direct path.

The processor may further cause the first communication node to perform: after receiving the second signal, estimating a second angle of arrival corresponding to the direct path.

The processor may further cause the first communication node to perform: receiving a positioning request signal from the second communication node before receiving the first signal; and determining whether the second communication node is located indoors or outdoors based on the positioning request signal.

In the performing of the positioning operation for the second communication node, the processor may further cause the first communication node to perform: transmitting information on the second time interval to a first positioning device, wherein the information on the second time interval may be used for the first positioning device to perform the positioning operation for the second communication node.

In the performing of the positioning operation for the second communication node, the processor may further cause the first communication node to perform: receiving information on an estimated position of the second communication node from the first positioning device after transmitting the information on the second time interval to the first positioning device; and transmitting information on the estimated position to the second communication node.

According to the exemplary embodiments of the positioning method and apparatus in the communication system, the performance of positioning operations based on signals transmitted from a specific communication node can be improved. When LOS conditions with other communication nodes cannot be easily secured due to reasons such as a communication node being located indoors, positioning for the communication node may not be easy. According to the exemplary embodiments of the positioning method and apparatus in the communication system, the performance for communication nodes under NLOS conditions can be improved based on variable control of reception gain during signal transmission and reception between the communication nodes, without requiring additional devices or infrastructure.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIGS. 3A and 3B are exemplary diagrams for describing exemplary embodiments of positioning schemes in a communication system.

FIGS. 4A and 4B are conceptual diagrams for describing a first exemplary embodiment of a reception signal-based positioning method in a communication system.

FIGS. 5A to 5D are conceptual diagrams for describing a second exemplary embodiment of a reception signal-based positioning method in a communication system.

FIGS. 6A to 6E are exemplary diagrams for describing a second exemplary embodiment of a reception signal-based positioning method in a communication system.

FIG. 7 is a flow chart for describing an exemplary embodiment of a positioning method in a communication system.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, B5G mobile communication network (6G communication network, etc.), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

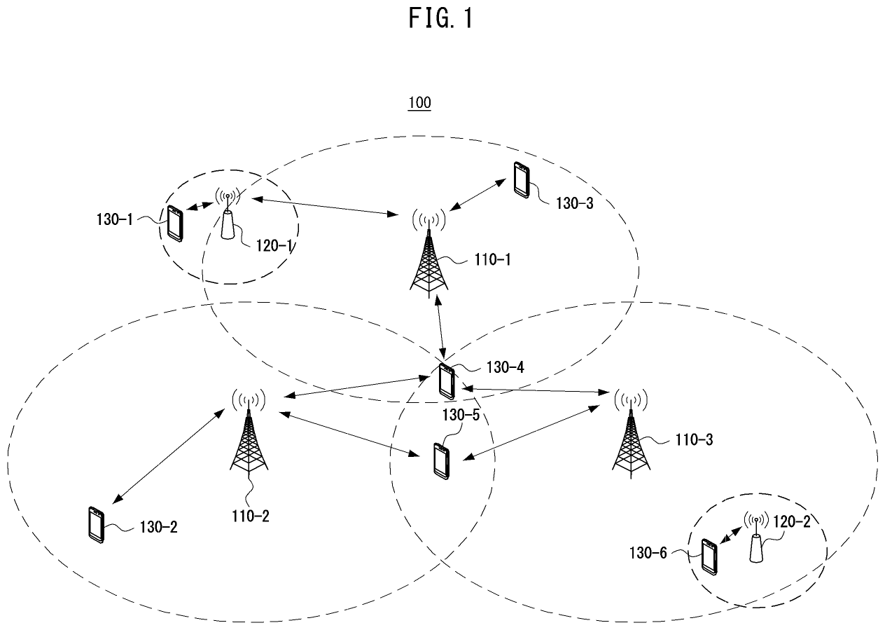

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

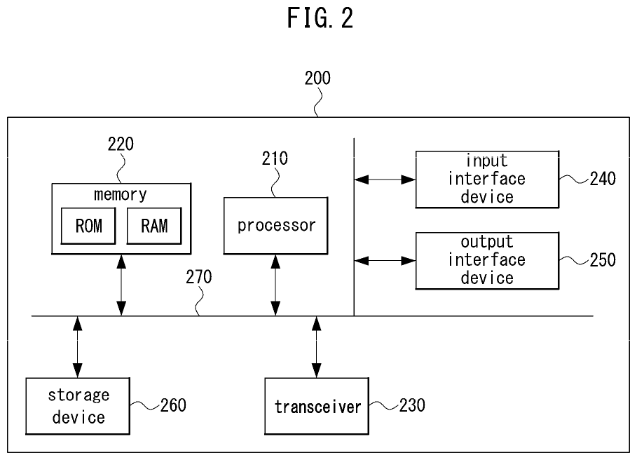

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IOT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for positioning in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a receiving node is described, a corresponding transmitting node may perform an operation corresponding to the operation of the receiving node. Conversely, when an operation of a transmitting node is described, a corresponding receiving node may perform an operation corresponding to the operation of the transmitting node.

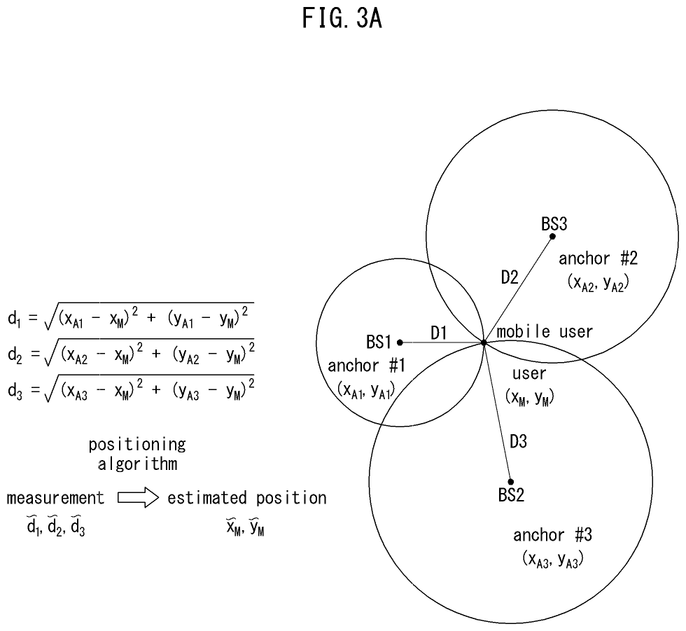

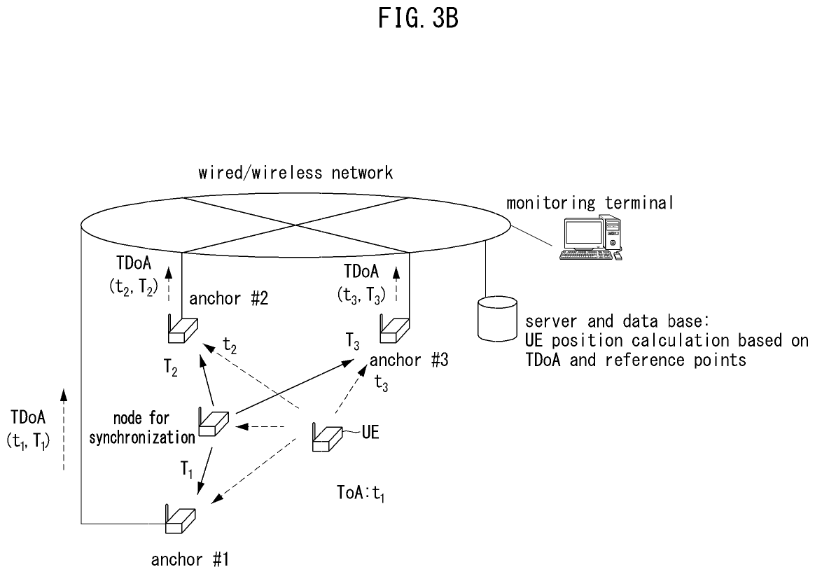

FIGS. 3A and 3B are exemplary diagrams for describing exemplary embodiments of positioning schemes in a communication system.

Referring to FIGS. 3A and 3B, positioning may be performed based on results of receiving radio signals transmitted and received in a communication system. In an exemplary embodiment of the communication system, a receiving node may perform positioning (i.e., position measurement) for itself or a transmitting node based on signals received wirelessly. Here, the positioning may be performed based on triangulation or the like based on a plurality of radio signals. For a triangulation-based positioning operation, schemes such as Time of Arrival (ToA), Time Difference of Arrival (TDoA), and Angle of Arrival (AoA) may be used. FIG. 3A illustrates an exemplary embodiment of the ToA scheme, and FIG. 3B illustrates an exemplary embodiment of the TDoA scheme.

Referring to FIG. 3A, a communication node (e.g., mobile user) may estimate its position based on signals received from a plurality of anchors (e.g., anchor #1, anchor #2, anchor #3, and the like). Alternatively, the communication network may estimate a position of a specific communication node (e.g., user) by receiving a signal from the specific communication node (e.g., user) through a plurality of anchors (e.g., base stations BS1, BS2, BS3, and the like).

Specifically, distances D1, D2, and D3 (or d1, d2, and d3) between the respective plurality of anchors and the specific communication node may be defined as in Equation 1 below based on coordinates of the plurality of anchors and coordinates of the specific communication node.

$${d}_{1} = \sqrt{{( {x}_{A 1} - {x}_{M} )}^{2} + {( {y}_{A 1} - {y}_{M} )}^{2}} \qquad [ Equation 1 ]$$

$${d}_{2} = \sqrt{{( {x}_{A 2} - {x}_{M} )}^{2} + {( {y}_{A 2} - {y}_{M} )}^{2}}$$

$${d}_{3} = \sqrt{{( {x}_{A 3} - {x}_{M} )}^{2} + {( {y}_{A 3} - {y}_{M} )}^{2}}$$

A radio wave arrival time may be measured based on a difference between a transmission time at a transmitting end and a reception time at a receiving end, and the distances d1, d2, and d3 between the respective plurality of anchors and the specific communication node may be estimated based on the radio wave arrival times and a speed of light. Through triangulation based on the estimated distances [symbol] , [symbol] , and [symbol] , estimated values of the coordinates ( [symbol] , [symbol] ) of the position (x_{M}, y_{M}) of the specific communication node may be calculated.

According to an exemplary embodiment of the ToA scheme, the communication node may estimate its own position in two dimensions by measuring arrival times of radio waves from at least three references (i.e., anchors). However, this scheme may have a limitation that times of all the reference points should be exactly synchronized with one common reference (e.g., master clock).

On the other hand, according to an exemplary embodiment of the TDoA scheme shown in FIG. 3B, positioning may be performed without accurate synchronization between the anchors. In the TDoA scheme, a separate communication node (e.g., ‘node for synchronization’) may be used for synchronization. Here, a position of a specific communication may be calculated based on differences between TOAs t₁, t₂, and t₃ between the specific communication node (e.g., UE) and the respective anchors and TOAs T₁, T₂, and T₃ between the node for synchronization and the respective anchors.

On the other hand, according to a round trip time (RTT) scheme, positioning may be performed without accurate synchronization between the anchors. According to the RTT scheme, a specific communication node (such as a terminal) may receive signal(s) from one or more reference points (such as base stations) and then transmit response(s) thereto. RTT(s) may be calculated based on time(s) when one or more reference points receive the response(s). Accordingly, distances between the specific communication node and the respective reference points may be estimated.

On the other hand, according to a connectivity-based positioning scheme, positioning may be performed based on reception strengths (e.g., received signal strength indicators (RSSIs)) of radio connections (e.g., Wi-Fi, Bluetooth, etc.) between communication nodes. However, this type of positioning scheme may require information on coordinates (or map information) of installation locations of reference points that provide radio connection services, and the positioning may not be performed normally in an environment where such information is not provided.

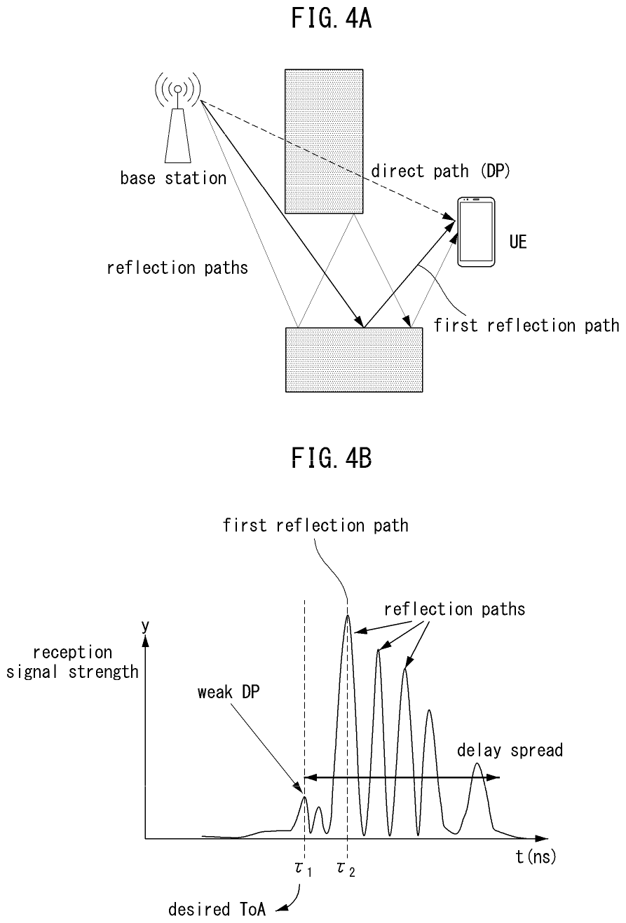

FIGS. 4A and 4B are conceptual diagrams representing the present disclosure for describing a first exemplary embodiment of a positioning method in a communication system.

Referring to FIGS. 4A and 4B, in a first exemplary embodiment of a reception signal-based positioning method, a positioning operation may be performed based on results of transmission and reception of radio waves (or radio signals). The first exemplary embodiment of the reception signal-based positioning method may be identical or similar to a part of the positioning schemes described with reference to FIGS. 3A and 3B. Hereinafter, in describing the first exemplary embodiment of the reception signal-based positioning method in the communication system with reference to FIGS. 4A and 4B, description redundant with those described with reference to FIGS. 1 to 3B may be omitted.

Referring to FIG. 4A, positioning according to results of transmission and reception of radio waves (or radio signals) may be easily performed when transmitting and receiving nodes are in a line-of-sight (LOS) condition. On the other hand, if the transmitting and receiving nodes are in a mutual non-line-of-sight (NLOS) condition, the accuracy of the positioning operation may be reduced.

For example, in an exemplary embodiment of a communication system using multiple antennas, when a direct path (DP) between transmitting and receiving nodes is blocked, reception signals received at the receiving node (such as UE) may be seen as being received by being reflected by another object after being transmitted from the transmitting node (e.g., base station). In other words, most of components of reception signals received at the receiving node may be regarded as being received through reflection paths rather than the direct path. In this case, the distance between the transmitting and receiving nodes may be perceived as being farther than it actually is. For example, when a path with the shortest distance among the reflection paths is called a first reflection path, a time required for a radio signal to be received through the first reflection path may be longer that a time required for a radio signal to be received through the direct path (i.e., it corresponds to the distance between the transmitting and receiving nodes). A delay spread may occur due to the components received through the reflection paths.

Referring to FIG. 4B, when a time interval (ToA, time delay, etc.) according to the direct path between the transmitting and receiving nodes is τ₁, the receiving node may wish to measure τ₁ to measure the distance between the transmitting and receiving nodes. However, when the direct path between the transmitting and receiving nodes is blocked, a strength of a signal through the direct path may be weak and thus τ₁ may not be easily measured. On the other hand, the receiving node may much more easily detect components received through the reflection paths rather than the direct path. Here, a component received first among the components received through the reflection paths may be regarded as a component corresponding to the first reflection path. When a time interval according to the first reflection path is τ₂, τ₂ may be greater than τ₁ which is the desired time interval. Accordingly, the distance between the transmitting and receiving nodes may be recognized as being farther than it actually is.

In an exemplary embodiment of the communication system, when a UE (or a user carrying the UE, etc.) is located indoors and there is a radio wave attenuation source such as a concrete wall between the UE and reference point(s) or base station(s), components received through reflection paths (e.g., components received after being reflected from the wall) may be measured to be stronger by a certain gap (10 to 20 dB, etc.) than a component received through a direct path. When the receiving node detects multipath fading signals with multiple reflected waves overlapping and performs channel estimation and demodulation based thereon, a very large positioning error may occur. Meanwhile, even when a LOS condition is secured between the base station (BS) and the user (UE), a positioning error due to multipath may occur in urban areas with many high-rise buildings. In the communication systems, techniques for improving the accuracy of reception signal-based positioning operations may be required.

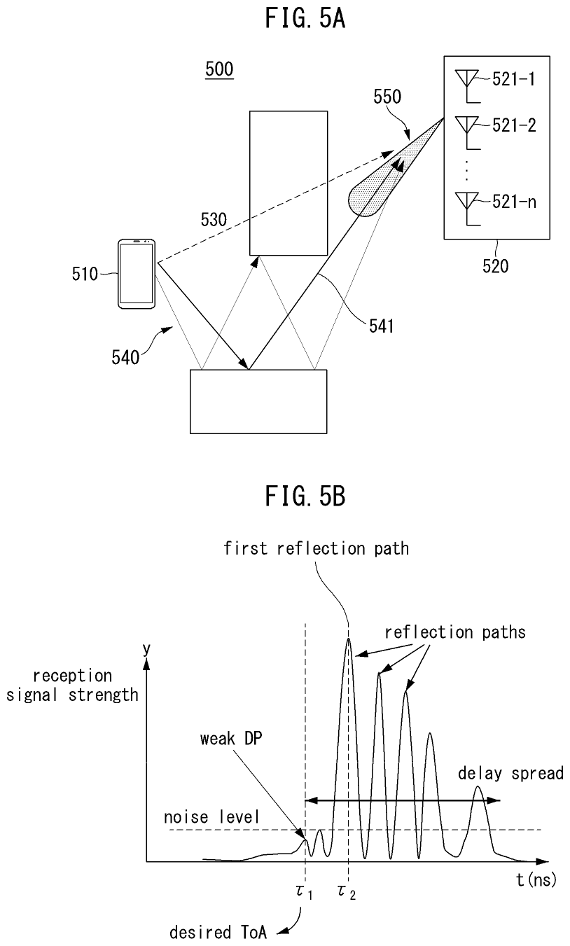

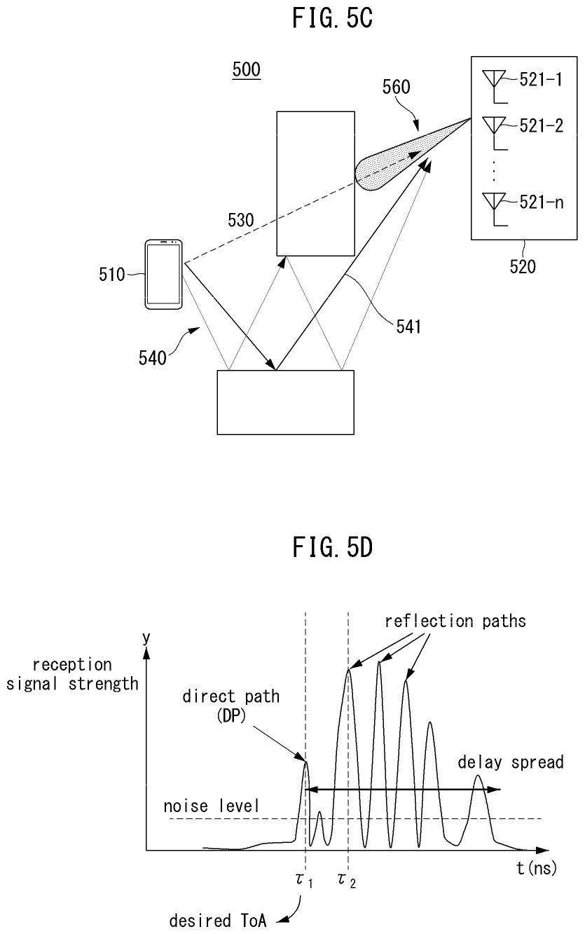

FIGS. 5A to 5D are conceptual diagrams for describing a second exemplary embodiment of a reception signal-based positioning method in a communication system.

Referring to FIGS. 5A to 5D, a communication system 500 may be identical or similar to the communication system described with reference to at least one of FIGS. 1 to 4B. In the communication system 500, positioning may be performed based on results of transmission and reception of radio signals between one or more communication nodes. Hereinafter, in describing the second exemplary embodiment of the reception signal-based positioning method in the communication system with reference to FIGS. 5A to 5D, description redundant with those described with reference to FIGS. 1 to 4B may be omitted.

Referring to FIGS. 5A and 5B, a transmitting node 510 may transmit a radio signal. A receiving node 520 may receive the radio signal transmitted from the transmitting node 510. The receiving node 520 may perform positioning for the transmitting node 510 based on results of receiving the radio signal transmitted from the transmitting node 510. Alternatively, in the communication system 500 or communication network including the receiving node 520, the positioning for the transmitting node 510 may be performed based on reception results at other communication nodes (not shown) receiving the radio signal transmitted from the transmitting node 510 and the reception result at the receiving node 520.

When the transmitting node 510 and the receiving node 520 are in an NLOS condition, signal transmission and reception may not be smooth. For example, a direct path 530 between the transmitting node 510 and the receiving node 520 may be blocked due to an obstacle. In other words, a component corresponding to the direct path 530 in the radio signal transmitted and received between the transmitting node 510 and the receiving node 520 may be received with a weaker strength compared to components corresponding to reflection paths 540.

In the second exemplary embodiment of the reception signal-based positioning method, the receiving node 520 may identify a path (hereinafter referred to as ‘first arrival path (FAP)’) corresponding to a component received first among components received with strengths equal to or higher than a preset noise level. Here, the FAP may be regarded as corresponding to a first reflection path 541.

In an exemplary embodiment of the communication system 500, the receiving node 520 may include one or more antennas 521-1, 521-2, . . . , and 521-n. The receiving node 520 may detect components received through one or more paths or their directions using the one or more antennas 521-1, 521-2, . . . , and 521-n.

The receiving node 520 may identify a component received through the first reflection path 541 among the reflection paths 540 (hereinafter referred to as ‘first reflection path component’). When a time interval corresponding to the component received through the direct path 530 (hereinafter referred to as ‘direct path component’) is τ₁ and a time interval corresponding to the first reflection path component is τ₂, τ₂ may be larger than τ₁ which is a desired time interval. Here, in order to more easily measure the first reflection path component or τ₂, the receiving node 520 may form a reception beam in a first beamforming direction 550 corresponding to the first reflection path component. Alternatively, the receiving node 520 may determine that a direction in which the FAP is received through the reception beam is the first beamforming direction 550. However, this is merely an example for convenience of description, and the second exemplary embodiment of the reception signal-based positioning method is not limited thereto.

Referring to FIGS. 5C and 5D, in the communication system 500, the receiving node 520 may perform an operation for measuring the direct path component received through the direct path 530, or τ₁ corresponding to the direct path component. For example, the receiving node 520 may increase a reception gain during at least part of a measurement time so that a reception strength of the direct path component is greater than the noise level. In this case, although the reception strength of the direct path component is still weaker than those of the components corresponding to the reflection paths 540, τ₁ may be easily measured because it is greater than the noise level. When the reception gain is increased and the reception strength of the direct path component becomes greater than the noise level as described above, the FAP may be changed from the first reflection path 541 to the direct path 530. Meanwhile, in order to more easily measure the direct path component or τ₁, the receiving node 520 may form a reception beam in a second beamforming direction 560 corresponding to the direct path component. Alternatively, the receiving node 520 may determine a direction in which the FAP is received through the reception beam as the second beamforming direction 560. However, this is merely an example for convenience of description, and the second exemplary embodiment of the reception signal-based positioning method is not limited thereto.

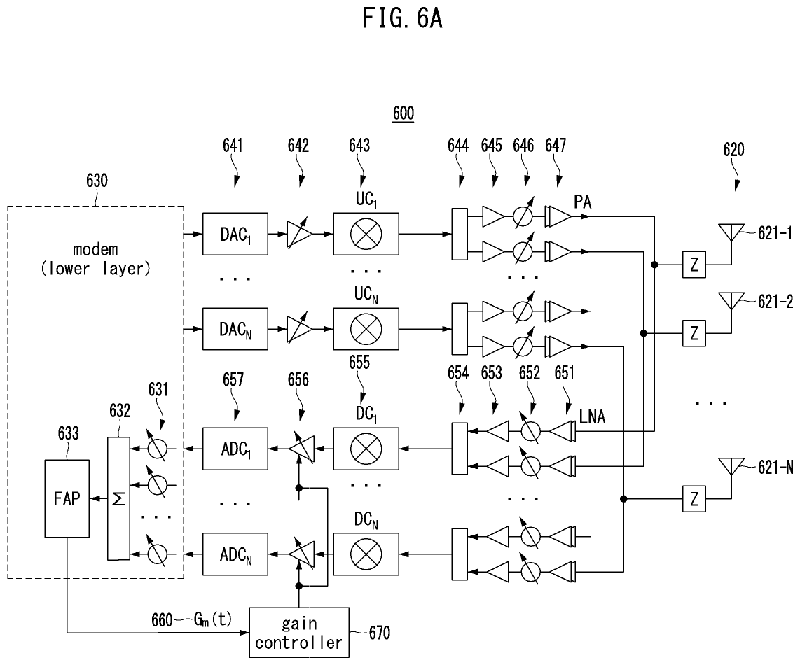

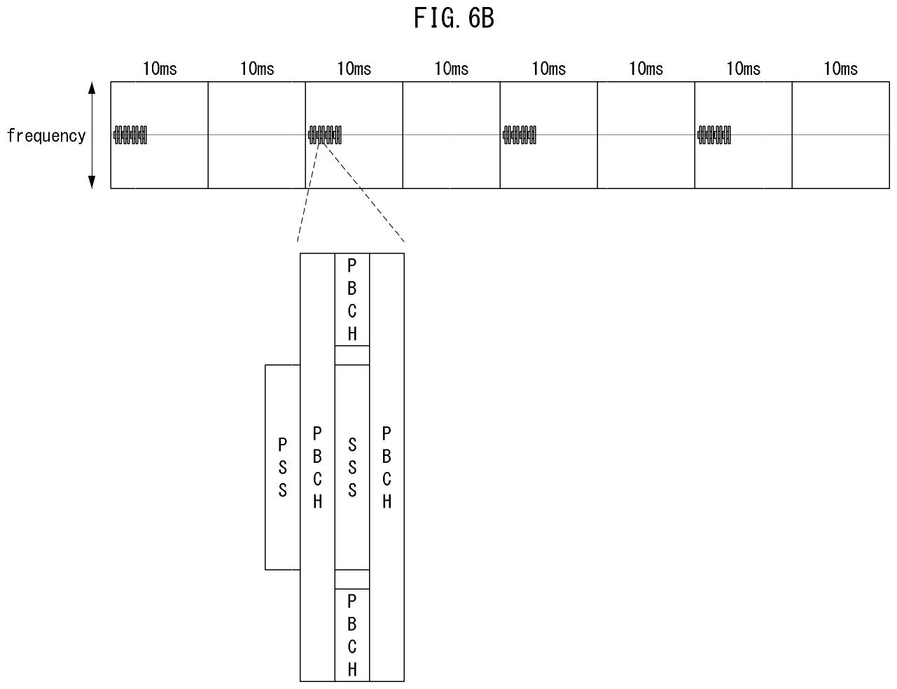

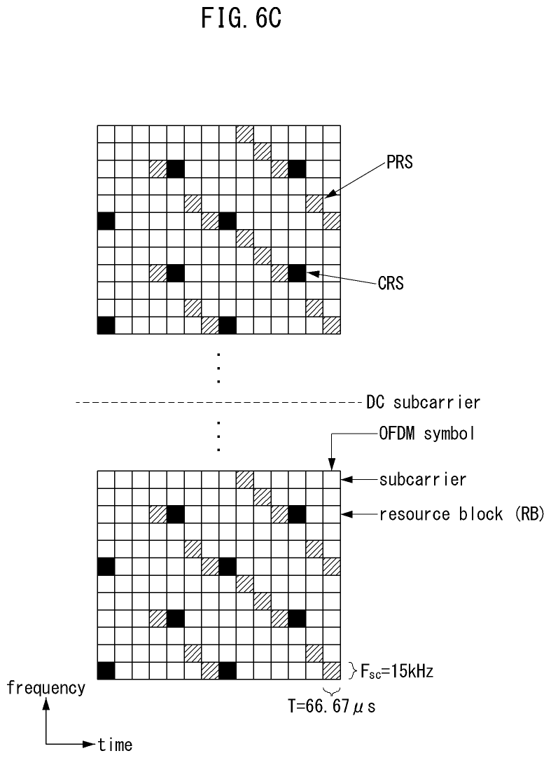

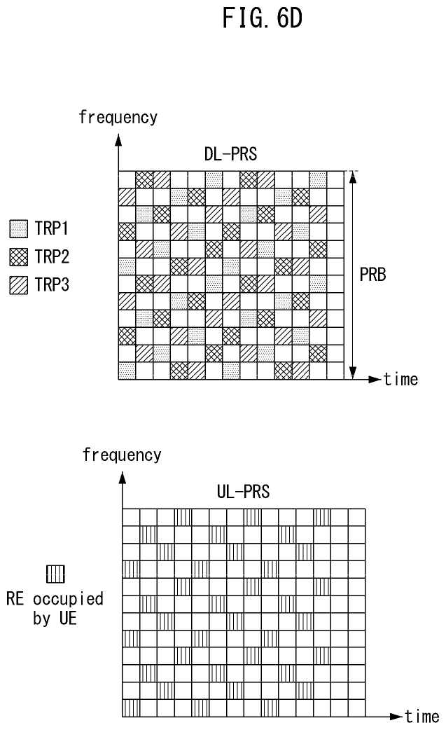

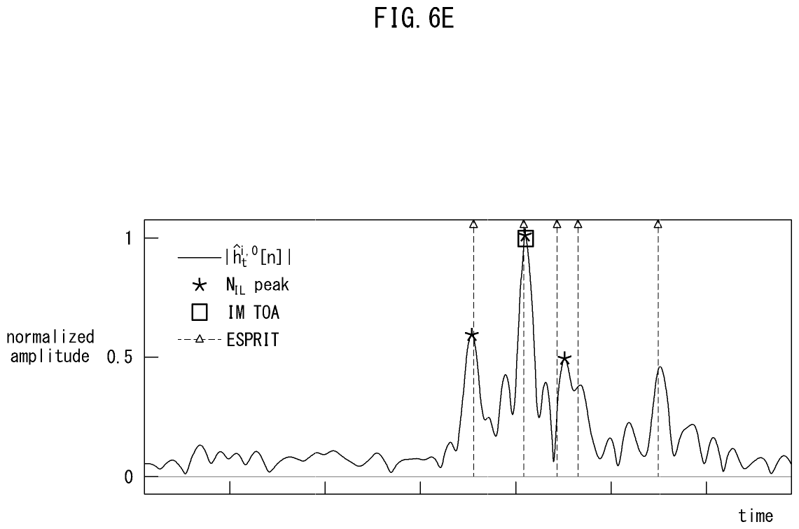

FIGS. 6A to 6E are exemplary diagrams for describing a second exemplary embodiment of a reception signal-based positioning method in a communication system.

Referring to FIGS. 6A to 6E, a communication system may be identical or similar to the communication system 500 described with reference to FIGS. 5A to 5D. The communication system may include a first communication node 600 and a second communication node (not shown). The first communication node 600 included in the communication system may be identical or similar to the receiving node 520 described with reference to FIGS. 5A to 5D. The first communication node 600 may receive a radio signal transmitted from the second communication node that is identical or similar to the transmitting node 510 described with reference to FIGS. 5A to 5D. Hereinafter, in describing the second exemplary embodiment of the reception signal-based positioning method in the communication system with reference to FIGS. 6A to 6E, description redundant with those described with reference to FIGS. 1 to 5D may be omitted.

Referring to FIG. 6A, the first communication node 600 may include a radio frequency (RF) transceiver block. The first communication node 600 may include an antenna unit 620, a modulator/demodulator (modem) 630, a transmitter, a receiver, and the like. The antenna unit 620 may include an antenna array. The antenna unit 620 may include one or more antennas 621-1, 621-2, . . . , and 621-N. The one or more antennas 621-1, 621-2, . . . , and 621-N may be identical or similar to the one or more antennas 521-1, 521-2, . . . , and 521-n of the receiving node 520 described with reference to FIGS. 5A to 5D. The first communication node 600 may receive radio signals using the one or more antennas 621-1, 621-2, . . . , and 621-N. The antennas included in this antenna unit 620 may operate as receiving antennas or transmitting antennas. Alternatively, the antennas included in the antenna unit 620 may operate as transmitting antennas and receiving antennas depending on cases. In order to switch transmitting/receiving roles of the antennas, the antenna unit 620 may further include switches Z. The first communication node 600 may transmit and/or receive radio signals through the antennas of the antenna unit 620. Such the transmission and/or reception operations may be performed based on digital beamforming. Alternatively, such the transmission and/or reception operations may be performed based on analog beamforming using RF phase shifter(s). The modem 300 may modulate data to be transmitted through the transmitter and the antenna unit 620. In addition, the modem may demodulate data received through the antenna unit 620 and the receiver.

The transmitter may include one or more digital-to-analog converters (DACs) 641, one or more variable gain amplifiers (VGAs) 642, one or more up-converters (UCs) 643, one or more power dividers 644, one or more RF amplifiers 645, one or more phase shifters 646, one or more power amplifiers (PAS) 647, and the like. However, this is merely an example for convenience of description, and exemplary embodiments of the transmitter in the communication system are not limited thereto. The first communication node 600 may transmit a signal modulated by the modem 630 through the antenna unit 620 via the components of the transmitter.

The receiver may include one or more low noise amplifiers (LNAs) 651, one or more phase shifters 652 (or one or more delay units 652), one or more RF amplifiers 653, one or more power combiners 654, one or more down-converters (DCs) 655, one or more VGAs 656, one or more analog-to-digital converters (ADCs) 657, and the like. However, this is merely an example for convenience of description, and exemplary embodiments of the receiver in the communication system are not limited thereto. The first communication node 600 may obtain information or data by demodulating a signal received through the antenna unit 620 at the modem 630.

A digital signal converted in the one or more ADCs 657 of the receiver may be input to a FAP estimator 633 through the one or more delay units 631 (such as digital delay units) and the combiner 632 included in the modem 630. The FAP estimator 633 may identify or estimate a component corresponding to a FAP among received components.

A reception gain applied to the one or more VGAs 656 included in the receiver of the first communication node 600 may be variably controlled based on a predetermined gain control function Gₘ(t) 660. The gain control function Gₘ(t) 660 may be determined by a gain controller 670. For example, the gain controller 670 of the first communication node 600 may variably control the reception gain so that the FAP estimator 633 detects a direct path component as the FAP.

Referring to FIG. 6B, in the communication system, a base station may periodically transmit synchronization signals blocks (SSBs) to synchronize with terminals and transmit basic system information for initial access to the terminals. The SSB may include a primary synchronization signal (PSS), a secondary synchronization signal (SSS), and the like. The SSB may further include a physical broadcast channel (PBCH) that broadcasts information such as a master information block (MIB). The SSB may further include a PBCH demodulation reference signal (DMRS) for decoding the PBCH. The terminals may perform time/frequency synchronization with the base station based on the SSB. The terminals may receive the MIB from the base station through the PBCH. The terminals may detect the SSB during a synchronization procedure and start an initial access procedure by decoding the detected SSB.

The SSBs may be transmitted periodically on specific subcarriers of an orthogonal frequency division multiplexing (OFDM) frame. In the SSB, the synchronization signals (e.g. PSS, SSS, etc.) and the PBCH may not be separated from each other in the time domain, and their positions in the time-frequency domain may vary depending on a subcarrier spacing (SCS) and a situation.

Referring to FIGS. 6C and 6D, in an exemplary embodiment of the communication system, positioning may be performed based on reference signals (RSS). Here, the reference signal may include a cell-specific reference signal (CRS) and/or a positioning reference signal (PRS) shown in FIG. 6C. Alternatively, the reference signal may include a downlink (DL)-positioning reference signal (PRS) and/or an uplink (UL)-sounding reference signal (SRS) shown in FIG. 6D. When using a DL-PRS or UL-SRS identical or similar to that shown in FIG. 6D for precise positioning, the receiving node may set a VGA gain to the maximum to match a minimum sensitivity power level rather than a period average received power during a SRS period, and perform a channel estimation process.

Referring to FIG. 6E, in an exemplary embodiment of the communication system, the first communication node 600 may perform the operations for positioning described with reference to FIGS. 5A to 5D based on results of receiving the SSBs described with reference to FIG. 6B, the reference signals described with reference to FIGS. 6C and 6D, and/or the like. Here, the reference signal may include, for example, a DL-PRS, UL-SRS, and/or the like. The first communication node 600 may measure time delay values corresponding to received signal components based on the received signals. For example, based on the received signals, the first communication node 600 may measure a time delay τ₁ corresponding to a direct path component among the received signal components as follows.

A baseband signal S (e.g., Sₗ^{p}) of a transmission signal transmitted from the second communication node and a pilot tone or pilot signal s (e.g., sₗ^{p}) in the reference signal may have a relationship identical to or similar to Equation 2 below.

$${s}_{l}^{p} ( t ) = {\sum }_{k = - {N}_{sc} / 2}^{k = - 1} {S}_{l}^{p} [ k + {N}_{sc} / 2 ] {e}^{j 2 π k Δ ft} + {\sum }_{k = 0}^{k = {N}_{sc} / 2 - 1} {S}_{l}^{p} [ k + {N}_{sc} / 2 ] {e}^{j 2 π ( k + 1 ) Δ ft} , t ∈ [ - {T}_{CP , l} , {T}_{s} ] \qquad [ Equation 2 ]$$

When the transmission signal expressed identically or similarly to Equation 2 is received through an NLOS multipath fading channel environment, a multipath channel impulse response (CIR) and a channel frequency response (CFR) may expressed as in Equation 3.

$$h ( τ ) = {\sum }_{l = 0}^{L - 1} {h}_{l} δ ( τ - {τ}_{l} ) {⟹}^{ℱ ( \cdot )} H ( f ) = {\sum }_{l = 0}^{L - 1} {h}_{l} {e}^{- j 2 π f {τ}_{l}} \qquad [ Equation 3 ]$$

An l-th OFDM symbol and a demodulated signal of a signal that passes through one or more ADCs 657 in the first communication node 600 and from which a cyclic prefix (CP) is removed may be expressed identically or similarly to Equation 4.

$${R}_{i , l}^{i} [ k ] = DFT \{ {r}_{t , l}^{i} [ n ] \} \qquad [ Equation 4 ]$$

Channel characteristics including the direct path may be estimated based on a least-square (LS) scheme using the reception signal expressed identically or similarly to Equation 4 and the pilot signal of the reference signal (such as SRS). For example, the channel characteristics including the direct path may be estimated identically or similarly to Equation 5.

$${\hat{H}}_{LS} {arg min}_{\{ H \}} {‖ Y - XH ‖}^{2} \qquad [ Equation 5 ]$$

In Equation 5, Y may correspond to a received signal vector R[k], X may correspond to the pilot symbol (e.g. S in Equation 2), and H may corresponds to the CFR vector in Equation 3. Based on Equation 2 to Equation 5, a channel response function may be estimated to be the same as or similar to Equation 6.

$${\hat{h}}_{t}^{i , p} [ n ] = IDFT \{ {\hat{H}}_{t}^{i , p} [ k ] \} , n = 0 , … , 2 {N}_{tot} - 1 \qquad [ Equation 6 ]$$

FIG. 6E illustrates a graph of a normalized magnitude (or normalized amplitude) of the channel response function ĥᵢ^{i,p}[n] (p=0) estimated as in Equation 6 over time. By applying an Estimation of Signal Parameters via Rotational Invariance Technique (ESPRIT) algorithm to the channel response function, each peak (N_{IL} peak) and its corresponding delay time may be identified. A peak with the largest value (IM TOA) among peaks may be regarded as corresponding to the first reflection path 541 described with reference to FIGS. 5A to 5D, and a peak preceding it may be regarded as corresponding to the direct path 530 described with reference to FIGS. 5A to 5D.

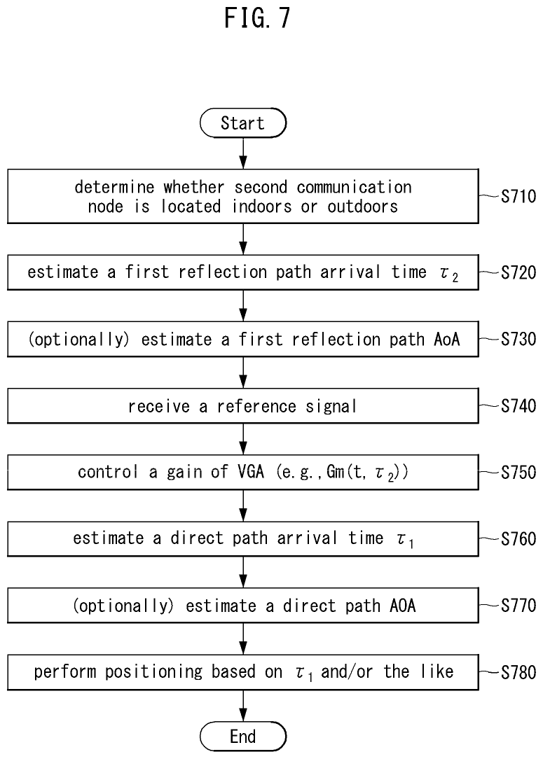

FIG. 7 is a flow chart for describing an exemplary embodiment of a positioning method in a communication system.

Referring to FIG. 7, a communication system may be identical or similar to the communication system 500 described with reference to FIGS. 5A to 5D. The communication system may include a first communication node and a second communication node. The first communication node and the second communication node included in the communication system may be identical or similar to the receiving node 520 and the transmitting node 510 described with reference to FIGS. 5A to 5D, respectively. The first communication node may be identical or similar to the first communication node 600 described with reference to FIGS. 6A to 6E. Hereinafter, in describing an exemplary embodiment of the positioning method in the communication system with reference to FIG. 7, description redundant with those described with reference to FIGS. 1 to 6E may be omitted.

The first communication node may perform operations for positioning the second communication node by receiving a radio signal transmitted from the second communication node. For example, the second communication node may transmit a positioning request signal. The first communication node may receive the positioning request signal transmitted from the second communication node. The first communication node may determine whether the second communication node is located indoors or outdoors based on the positioning request signal received from the second communication node (S710). In the step S710, the first communication node may determine whether the second communication node is located indoors or outdoors based on an algorithm for indoor/outdoor distinction. Alternatively, the positioning request signal may indicate request of information on whether the second communication node is located indoors or outdoors. In this case, the first communication node may identify whether the second communication node is located indoors or outdoors based on the information indicated by the positioning request signal. In an exemplary embodiment of the communication system, when it is determined that the second communication node is located indoors, the first communication node may perform the operations according to steps S720 to S780. Alternatively, in another exemplary embodiment of the communication system, the first communication node may perform the operations according to steps S720 to S780 regardless of whether the second communication node is located indoors or outdoors.

The first communication node may receive a first signal transmitted from the second communication node. Here, the first signal may be a type of reference signal. The first signal may correspond to the UL-SRS described with reference to FIG. 6D. However, this is merely an example for convenience of description, and exemplary embodiments of the positioning method in the communication system are not limited thereto. The first communication node may estimate a first arrival time based on a result of receiving the first signal (S720). Here, the first arrival time may be the same as or similar to the delay time 12 corresponding to the first reflection path 541 described with reference to FIGS. 5A to 5D. The first arrival time may also be referred to as ‘first reflection path arrival time’. Meanwhile, the first communication node may estimate an angle of arrival (i.e., first reflection path AOA) of a component received through the first reflection path based on the first signal (S730). At least some of the operations according to the steps S720 and S730 may be optionally performed. For example, after performing the operation according to the step S720, the first communication node may selectively perform the operation according to the step S730. Although the step S730 is illustrated as being performed after the step S720 in FIG. 7, this is merely an example for convenience of description, and exemplary embodiments of the positioning method in the communication system are not limited thereto. For example, in the communication system, the first communication node may estimate the first reflection path AOA based on an operation result of the step S720 (S730). The first communication node may increase a reception gain of the component corresponding to the first reflection path by steering the direction of reception antenna(s) or reception beam according to the estimated first reflection path AOA. Accordingly, when performing the estimation operation of the step S720, the estimation performance of the first arrival time 12 may be improved.

After the step S730, the first communication node may increase a reception gain when receiving a radio signal transmitted from the second communication node. This may be the same as or similar to those described with reference to FIGS. 5C, 5D, and 6A. For example, the first communication node may receive a second signal transmitted from the second communication node (S740). Here, the second signal may be a type of reference signal. The second signal may correspond to the UL-SRS described with reference to FIG. 6D. The second signal may correspond to the first signal that is retransmitted. However, this is merely an example for convenience of description, and exemplary embodiments of the positioning method in the communication system are not limited thereto.

The first communication node may determine a gain control function Gₘ(t) that is the same as or similar to that described with reference to FIG. 6A. The gain control function may be defined to increase the reception gain until before the first arrival time 12 estimated in the step S720. The gain control function defined as described above may be expressed as Gₘ(t, τ₂). For example, the gain control function may be defined identically or similarly to Equation 7.

$${G}_{m} ( t , {τ}_{2} ) = {G}_{max} ( for t < {τ}_{2} ) \qquad [ Equation 7 ]$$

$${G}_{m} ( t , {τ}_{2} ) = {G}_{max} - 20 dB ( for t \geq {τ}_{2} )$$

The first communication node may variably control the reception gain for the second signal received in the step S740 based on the gain control function Gₘ(t) defined as Equation 7 (S750). Although the step S750 is illustrated as being performed after the step S740 in FIG. 7, this is merely an example for convenience of description, and exemplary embodiments of the positioning method in the communication system are not limited thereto. For example, in the communication system, the first communication node may define the gain control function Gₘ(t) that is the same as or similar to Equation 7 based on the operation result according to the step S720. The first communication node may change the reception gain of the variable gain amplifier based on the defined gain control function Gₘ(t) (S750), and may receive the second signal transmitted from the second communication node.

The first communication node may estimate a second arrival time τ₁ based on a result of receiving the second signal in the steps S740 and S750 (S760). Here, the second arrival time τ₁ may be the same or similar to the delay time τ1 corresponding to the direct path 530 described with reference to FIGS. 5A to 5D. The second arrival time may also be referred to as a direct path arrival time. Meanwhile, the first communication node may estimate an angle of arrival (i.e., direct path AOA) of a component received through the direct path based on the second signal (S770). At least some of the operations according to the steps S760 and S770 may be selectively performed. For example, the first communication node may selectively perform the operation according to the step S770 after performing the operation according to the step S760.

Although the step S770 is illustrated as being performed after the step S760, this is merely an example for convenience of description, and exemplary embodiments of the positioning method in the communication system are not limited thereto. For example, in the communication system, the first communication node may estimate the direct path AOA based on the operation result according to the step S770 (S770). The first communication node may increase the reception gain for a component corresponding to the direct path by steering the direction of reception antenna(s) or reception beam according to the estimated direct path AOA. In this case, the direct path component may be amplified. For example, the direct path component may be amplified in proportion to the number of antennas due to effects such as constructive interference. On the other hand, the reflection path component(s) may be reduced (or attenuated). Accordingly, when performing the estimation operation of the step S760, the estimation performance of the second arrival time τ1 may be improved.

The first communication node may perform operations for positioning the second communication node based on the second arrival time τ₁ estimated in the step S760 (S780). For example, the first communication node may transmit information on the second arrival time τ₁ estimated in the step S760, information on the direct path AOA estimated in the step S770, and the like to a first positioning device included in the communication system. Here, the first positioning device may be one of communication nodes included in the communication system. Alternatively, the first positioning device may be a device connected to at least one of communication nodes included in the communication system. The communication system may include at least a third communication node and a fourth communication node. The third communication node and the fourth communication node may perform the same or similar operations as the operations according to the steps S710 to S780, respectively. Each of the first communication node, the third communication node, and the fourth communication node may estimate the direct path arrival time based on the result of receiving the signal received from the second communication node. The first positioning device may use triangulation to identify the position of the second communication node based on the direct path arrival times respectively estimated from the first, third, and fourth communication nodes.

The first positioning device may transmit information of the identified position of the second communication node to the first communication node. The first communication node may perform communication with the second communication node based on the identified position of the second communication node. The first communication node may transmit information of the identified position of the second communication node to the second communication node. The second communication node may identify its own position through the first communication node.

Alternatively, the first positioning device may transmit information of the identified position of the second communication node to at least some of the first, third, and fourth communication nodes. The first, third, and/or fourth communication node may perform communication with the second communication node based on the identified position of the second communication node. The first, third, and/or fourth communication node may transmit location information of the identified position of the second communication node to the second communication node. The second communication node may identified its own position through the first, third, and/or fourth communication node.

Meanwhile, in an exemplary embodiment of the communication system, the following operations may be optionally performed. When the position, direction and/or distance of the second communication node is estimated after the operations according to at least some of the steps S710 to S780 are performed, the first communication node may receive the first or second signal retransmitted from the second communication node for more accurate positioning. When receiving the retransmitted first or second signal, the first communication node may steer the antenna(s) or reception beam toward the first reflection AOA or the second reflection path AOA.

In an exemplary embodiment of the communication system, adjustment of the direction of the reception beam (or steering of the reception beam) may be implemented in an analog scheme, a digital scheme, and/or the like. The digital beam steering may be implemented by adjusting the delay units 631 or 652 described with reference to FIG. 6A. For example, when the one or more ADCs 657 perform sampling at 800 MHz for a bandwidth 100 MHz mode, the first communication node 600 may adjust the one or more digital delays 631 based on an N-multiple of Ts= 1/400 M=1.25 ns. After the time delay is performed as described above, a digital beam steering effect may be obtained by performing a combining operation in the combiner 632. Through this, an angle of the beam direction determined according to a spacing d between antennas of the first communication node and a distance r between the first and second communication nodes may be finely adjusted. After performing such the digital beam steering process, the FAP estimation unit 633 may detect a FAP signal. This may be identical or similar to the process of obtaining the channel response functions CIR or CFR by the LS scheme as shown in Equation 5.

When estimating the AoA or TDoA for the second communication node through the operations described with reference to FIG. 7, the position (2-dimensional position, 3-dimensional position, etc.) of the second communication node may be estimated based on triangulation.

In an exemplary embodiment of the positioning method in the communication system described with reference to FIG. 7, the second communication node may correspond to a terminal, and the first, third, and fourth communication nodes may correspond to network entities such as base stations. However, this is merely an example for convenience of description, and exemplary embodiments of the positioning method in the communication system are not limited thereto. For example, in another exemplary embodiment of the positioning method in the communication system, the second communication node may correspond to a network entity such as a base station, and the first, third, and fourth communication nodes may correspond to terminals. Alternatively, the first to fourth communication nodes may all correspond to terminals, or all may correspond to base stations, or the like.

According to the exemplary embodiments of the positioning method and apparatus in the communication system, the performance of positioning operations based on signals transmitted from a specific communication node can be improved. When LOS conditions with other communication nodes cannot be easily secured due to reasons such as a communication node being located indoors, positioning for the communication node may not be easy. According to the exemplary embodiments of the positioning method and apparatus in the communication system, the performance for communication nodes under NLOS conditions can be improved based on variable control of reception gain during signal transmission and reception between the communication nodes, without requiring additional devices or infrastructure.

However, the effects that the exemplary embodiments of the positioning method and apparatus can achieve in the communication system are not limited to those mentioned above. Other effects not mentioned are expected to be clearly understood by those skilled in the art in the technical field to which the present disclosure belongs, based on the configurations described in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operation method of a first communication node in a communication system, the operation method comprising:
receiving a first signal from a second communication node of the communication system;
estimating a first time interval corresponding to a first path detected as a first arrival path (FAP) among one or more paths through which the first signal is received;
defining a first gain control function based on the estimated first time interval;
receiving a second signal transmitted from the second communication node by variably controlling a reception gain based on the first gain control function;
estimating a second time interval corresponding to a direct path (DP) between the first and second communication nodes, based on a result of receiving the second signal based on the first gain control function; and
transmitting relative distance information on the second time interval to a first positioning device,
wherein the information on the second time interval is used for the first positioning device to perform a positioning operation for the second communication node.

2. The operation method according to claim 1, further comprising, after receiving the first signal, estimating a first angle of arrival corresponding to the FAP.

3. The operation method according to claim 1, wherein the first gain control function is defined to change the reception gain of the first communication node from a first gain to a second gain, based on the estimated first time interval.

4. The operation method according to claim 1, wherein the receiving of the second signal comprises:
controlling a reception gain for a component received before the estimated first time interval to a first gain, based on the first gain control function; and
controlling a reception gain for a component received after the estimated first time interval to a second gain that is smaller than the first gain,
wherein the second time interval has a smaller value than the first time interval.

5. The operation method according to claim 1, wherein in the estimating of the second time interval, when the estimated second time interval and the estimated first time interval have a same value, the first path is determined to correspond to the direct path.

6. The operation method according to claim 1, further comprising, after receiving the second signal, estimating a second angle of arrival corresponding to the direct path,
wherein in the transmitting of the information on the second time interval to the first positioning device, information on the second angle of arrival is transmitted to the first positioning device together with the information on the second time interval.

7. The operation method according to claim 1, further comprising:
receiving a positioning request signal from the second communication node before receiving the first signal; and
determining whether the second communication node is located indoors or outdoors based on the positioning request signal.

8. The operation method according to claim 1, further comprising:
receiving information on an estimated position of the second communication node from the first positioning device after the transmitting to the first positioning device; and
performing communication with the second communication node based on the information on the estimated position.

9. The operation method according to claim 1, further comprising:
receiving information on an estimated position of the second communication node from the first positioning device after the transmitting to the first positioning device; and
transmitting information on the estimated position to the second communication node.

10. A first communication node in a communication system, comprising a processor,
wherein the processor causes the first communication node to perform:
receiving a first signal from a second communication node of the communication system;
estimating a first time interval corresponding to a first path detected as a first arrival path (FAP) among one or more paths through which the first signal is received;
defining a first gain control function based on the estimated first time interval;
receiving a second signal transmitted from the second communication node by variably controlling a reception gain based on the first gain control function;
estimating a second time interval corresponding to a direct path (DP) between the first and second communication nodes, based on a result of receiving the second signal based on the first gain control function; and
performing a positioning operation for the second communication node based on information on the second time interval.

11. The first communication node according to claim 10, wherein the processor further causes the first communication node to perform: after receiving the first signal, estimating a first angle of arrival corresponding to the FAP.

12. The first communication node according to claim 10, wherein in the receiving of the second signal, the processor further causes the first communication node to perform:
controlling a reception gain for a component received before the estimated first time interval to a first gain, based on the first gain control function; and
controlling a reception gain for a component received after the estimated first time interval to a second gain that is smaller than the first gain,
wherein the second time interval has a smaller value than the first time interval.

13. The first communication node according to claim 10, wherein in the estimating of the second time interval, the processor further causes the first communication node to perform: when the estimated second time interval and the estimated first time interval have a same value, determining the first path as corresponding to the direct path.

14. The first communication node according to claim 10, wherein the processor further causes the first communication node to perform: after receiving the second signal, estimating a second angle of arrival corresponding to the direct path.

15. The first communication node according to claim 10, wherein the processor further causes the first communication node to perform:
receiving a positioning request signal from the second communication node before receiving the first signal; and
determining whether the second communication node is located indoors or outdoors based on the positioning request signal.

16. The first communication node according to claim 10, wherein in the performing of the positioning operation for the second communication node, the processor further causes the first communication node to perform: transmitting information on the second time interval to a first positioning device, wherein the information on the second time interval is used for the first positioning device to perform the positioning operation for the second communication node.

17. The first communication node according to claim 16, wherein in the performing of the positioning operation for the second communication node, the processor further causes the first communication node to perform:
receiving information on an estimated position of the second communication node from the first positioning device after transmitting the information on the second time interval to the first positioning device; and
transmitting information on the estimated position to the second communication node.
